(19) United States
(12) Patent Application Publication
(10) Pub. No.: US 2023/0415251 A1
(43) Pub. Date: Dec. 28, 2023

(54) ELECTRICAL DISCHARGE MACHINING APPARATUS

(71) Applicant: HIGHLIGHT TECH CORP., Tainan City (TW)

(72) Inventors: CHWUNG-SHAN KOU, Tainan City (TW); WEN-YUNG YEH, Tainan City (TW); CHANG-YING CHEN, Tainan City (TW)

(73) Assignee: HIGHLIGHT TECH CORP., Tainan City (TW)

(21) Appl. No.: 18/210,682

(22) Filed: Jun. 16, 2023

Related U.S. Application Data
(60) Provisional application No. 63/355,107, filed on Jun. 24, 2022.

(30) Foreign Application Priority Data
Sep. 30, 2022 (TW) 111137349
Apr. 19, 2023 (TW) 112114522

(51) Int. Cl. B23H 7/22

(52) U.S. Cl. CPC B23H 7/22

(57) ABSTRACT

Disclosed is an electrical discharge machining apparatus at least comprising a carrier platform, an electrical discharge machining unit and a repairing device. The carrier platform is used for carrying at least one to-be-machined object. The electrical discharge machining unit comprises at least one electrode and a power supply unit, and is used for performing an electrical discharge machining procedure on a machined target area of the to-be-machined object by the electrode along a machining direction. When there is an area to be repaired on an appearance of the electrode, the repairing device performs a repairing procedure on the electrode, thereby achieving effects of stable electrical discharge and preventing short-circuit problem in the electrical discharge machining procedure.

### CROSS-REFERENCE TO RELATED APPLICATION

This application claims priority to U.S. Provisional Patent Application No. 63/355,107, filed on Jun. 24, 2022; claims priority from Taiwan Patent Application No. 111137349, filed on Sep. 30, 2022; and claims priority from Taiwan Patent Application No. 112114522, filed on Apr. 19, 2023, each of which is hereby incorporated herein by reference in its entireties.

### BACKGROUND OF THE INVENTION

### 1. Field of Invention

The invention relates to a machining apparatus, and more particularly to an electrical discharge machining apparatus.

### 2. Related Art

With the booming semiconductor industry, electrical discharge machining technology has been commonly used to machine ingots or wafers. Electrical discharge machining (EDM) is a manufacturing process wherein sparks are generated by electrical discharges thereby a desired shape of a to-be-machined object can be obtained. A dielectric material separates two electrodes and a voltage is applied to generate rapidly recurring current discharges between the two electrodes to machine the to-be-machined object. Electrical discharge machining technology uses two electrodes, one of which is called the tool electrode, or the discharge electrode, while the other is called the workpiece electrode, connected to the to-be-machined object. During electrical discharge machining, there is no physical contact between the discharge electrode and the workpiece electrode.

When the potential difference between the two electrodes is increased, the electric field between the two electrodes becomes greater until the intensity of the electric field exceeds the dielectric strength, causing dielectric breakdown, current flows through the two electrodes, and part of the material is removed. Once the current stops, new dielectric material is conveyed into the inter-electrode electric field, enabling the partial material to be carried away and restoring the dielectric insulating effect. After a current flow, the potential difference between the two electrodes is restored to what it was before the dielectric break down, so that a new dielectric breakdown can occur to repeat the cycle.

However, the disadvantage of the current electrical discharge machining technology is that the roughness of the cut surface is not good, and there are quite a few surface cracks on the cut surface, which even extend along the non-cut direction, resulting in cracking effect in an unexpected direction. Moreover, in the existing electrical discharge machining technology, for example, when cutting an ingot, a jig is used to clamp a periphery of the ingot, that is, the side edge of the ingot is radially clamped to prevent scrolling or displacement. However, since the cut surface of the ingot is also located in the radial direction, the conventional technology can only cut the ingot exposed on the outer side of the jig, and cannot cut the area where the jig and the ingot overlap, so in the conventional technology, the machine or apparatus needs to be shut down to readjust a position to enable cutting again. In addition, the existing electrical discharge machining technology can only cut or thin one wafer at a time, which is quite slow in machining. Furthermore, the existing electrical discharge machining technology only uses a single cutting wire, and the existing electrical discharge machining apparatuses do not have a quick-disassemble design, if the cutting wire breaks accidentally, the electrical discharge machining apparatus needs to be shut down and it takes a lot of time to complete replacement.

### SUMMARY OF THE INVENTION

In view of the above, one object of the invention is to provide an electrical discharge machining apparatus to solve the above-mentioned problems of the prior art.

In order to achieve the aforementioned object, the invention provides an electrical discharge machining apparatus at least comprising: a carrier platform for carrying at least one to-be-machined object; an electrical discharge machining unit comprising at least one electrode and a power supply unit, and used for performing an electrical discharge machining procedure on a machined target area of the to-be-machined object on the carrier platform by the electrode along a machining direction, wherein the electrode is in a suspended state in an electrical discharge section, the power supply unit provides a first power source to the electrode and the to-be-machined object in the electrical discharge machining procedure for applying an electrical discharge energy to the machined target area of the to-be-machined object through the electrode located in the electrical discharge section; and a repairing device for performing a repairing procedure on an area to be repaired of an appearance of the electrode to repair the appearance of the electrode.

Preferably, the repairing device performs the repairing procedure on the electrode while the electrode performs the electrical discharge machining procedure on the machined target area.

Preferably, the repairing device performs the repairing procedure on the electrode before or after the electrode performs the electrical discharge machining procedure on the machined target area.

Preferably, the repairing device repairs the appearance of the electrode in a quantitative adjustment manner according to a wear rate of the electrode and a feed speed of the electrical discharge machining procedure.

Preferably, the repairing device repairs the appearance of the electrode in a dynamic adjustment manner according to a real-time state of the electrode.

Preferably, the repairing device comprises a dressing element, and a relative displacement is generated between the dressing element and the electrode during the repairing procedure to repair the appearance of the electrode.

Preferably, the repairing device comprises a lifting mechanism and/or a translation mechanism for disposing the dressing element so that the dressing element is capable of moving to generate the relative displacement with the electrode.

Preferably, the dressing element is a laser source, a cutter or a grinding element.

Preferably, the repairing device further comprises a chip removal element for removing a residual chip generated when repairing the appearance of the electrode while the repairing device performs the repairing procedure.

Preferably, the repairing device comprises a scrolling mechanism for scrolling the electrode during the repairing procedure, so that the area to be repaired of the appearance of the electrode keeps away from the machined target area of the to-be-machined object for repairing the appearance of the electrode.

Preferably, the repairing device further comprises a slitting element for dividing the electrode in the electrical discharge section into a plurality of electrode strips parallel to one another.

Preferably, the electrical discharge machining unit further comprises a clamping element for clamping at least one side of the electrical discharge section of the electrode when the electrode performs the electrical discharge machining procedure, and releasing the at least one side of the electrical discharge section of the electrode when the repairing device performs the repairing procedure.

Preferably, the electrical discharge machining apparatus further comprises a slag removal unit, when the electrical discharge machining unit performs the electrical discharge machining procedure on the to-be-machined object, the slag removal unit provides at least one external force to remove residues produced when the electrode applies the electrical discharge energy to the to-be-machined object.

Preferably, the slag removal unit adjusts an applied direction or an applied position of the external force according to a shape of the to-be-machined object to remove the residues.

Preferably, the electrical discharge machining unit further comprises: a jig composed of at least two carrying members and at least two holding members correspondingly assembled, wherein the two holding members are disposed on two seat bodies, and the two seat bodies are moving mechanisms or rotating mechanisms, so that when the electrical discharge machining unit performs the electrical discharge machining procedure along the machining direction, the electrical discharge section of the electrode and the machined target area of the to-be-machined object move relative to each other in a reciprocating or cyclical manner.

Preferably, the electrode abuts against the two carrying members in a surrounding manner or abuts against the two carrying members with two sides of the electrode respectively, so that the electrode is in the suspended state in the electrical discharge section.

Preferably, the repairing device further comprises an orientation correction element for adjusting a relative orientation of the electrode and the to-be-machined object to correct the machining direction according to a deviation phenomenon in the machining direction of the electrode.

Preferably, the repairing device moves a position of the electrode with the area to be repaired appearing on the appearance of the electrode, so that the area to be repaired keeps away from the machined target area of the to-be-machined object, and the area to be repaired is a fracture phenomenon or a fracture sign.

Preferably, a quantity of the electrode is multiple, and the electrodes are arranged parallel to one another along a first direction and/or a third direction in the electrical discharge section, wherein the third direction is perpendicular to the first direction.

Preferably, wherein the repairing device further comprises an adjusting element, and the adjusting element separates the electrodes so that the electrodes are maintained to be parallel to one another in the electrical discharge section.

Preferably, the electrical discharge machining unit further comprises a separation column, and the electrodes abut against the separation column, so that the electrodes are arranged parallel to one another in the electrical discharge section.

Preferably, the electrical discharge machining apparatus of the invention further comprises a stabilizing member, the stabilizing member having a plurality of guide grooves for movably accommodating the electrodes, and being used to stabilize and guide the electrodes, so that the electrodes being capable of performing the electrical discharge machining procedure along the machining direction.

Preferably, the repairing device moves a position of at least one of the electrodes with the area to be repaired appearing on the appearance of the electrodes, so that the area to be repaired keeps away from the machined target area of the to-be-machined object, and the area to be repaired is a fracture phenomenon or a fracture sign.

In summary, the electrical discharge machining apparatus according to the invention has the following advantages:
(1) The repairing device is capable of repairing the appearance of the electrode through relative displacements between a dressing element and the electrode to prevent short-circuit problem in the electrical discharge machining procedure.
(2) The repairing device is capable of keeping away from the machined target area of the to-be-machined object by scrolling or moving the electrode to avoid short-circuit problem in the electrical discharge machining procedure.
(3) A chip removal element is capable of removing chips and other substances remaining on the dressing element and/or the electrode through relative displacements between the dressing element and the electrode. A slag removal unit is capable of providing an external force for one machined target area or more than one machined target areas to help remove residues generated by the electrical discharge machining procedure or the repairing procedure.
(4) A slitting element is capable of cutting or dividing the electrical discharge section of the electrode into a plurality of electrode strips through relative displacements between the dressing element and the electrode, thereby avoiding uneven wear problem of the plate electrode.
(5) An orientation correction element is capable of correcting the machining direction of the electrode and the to-be-machined object, thereby avoiding deviation of the machining direction.
(6) A clamping element is capable of clamping the electrode to prevent the electrode from changing the machining direction due to being pulled.
(7) An adjusting element is capable of keeping the electrodes parallel to one another to avoid skewing and unevenness on a surface of the to-be-machined object after electrical discharge machining.
(8) A stabilizing member is capable of reducing chattering of the electrode, serving as a separation column to provide a guiding effect, and serving as an electrical contact.

In order to enable the examiner to have a further understanding and recognition of the technical features of the invention and the technical efficacies that can be achieved, preferred embodiments in conjunction with detailed explanation are provided as follows.

### BRIEF DESCRIPTION OF THE DRAWINGS

FIGS. 1A-1B are front views of an electrical discharge machining apparatus of the invention, wherein FIGS. 1A and 1B are schematic diagrams of different implementation examples.

FIGS. 2A-2C are top views of partial structures of the electrical discharge machining apparatus of the invention, multiple electrodes in a surrounding design are shown in FIG. 2A, one electrode in a surrounding design is shown in FIG. 2B, and one electrode in a bridging design is shown in FIG. 2C.

FIGS. 3A-3B are schematic diagrams of configuration of a jig of the invention using a plurality of carrying members to arrange the electrodes in parallel to one another, wherein FIG. 3A and FIG. 3B are different implementation examples, FIG. 3A shows multiple electrodes in parallel to one another in a machining direction F sequentially performing an electrical discharge machining procedure on single machined target area, and FIG. 3B shows multiple electrodes in parallel to one another in a first direction X performing the electrical discharge machining procedure on multiple machined target areas simultaneously.

FIGS. 4A-4B are schematic diagrams of a phenomenon of inconsistent wear degree of the electrodes during the electrical discharge machining procedure, wherein FIGS. 4A and 4B are schematic diagrams obtained from different viewing angles.

FIGS. 5A-5B are schematic diagrams of a repairing device of the electrical discharge machining apparatus of the invention provided with a dressing element, wherein FIGS. 5A and 5B are schematic diagrams obtained from different viewing angles.

FIGS. 6A-6C are schematic diagrams of the repairing device of the electrical discharge machining apparatus of the invention provided with a lifting mechanism, wherein FIGS. 6A, 6B and 6C are schematic diagrams of different implementation examples.

FIGS. 7A-7B are schematic diagrams of the repairing device of the electrical discharge machining apparatus of the invention provided with a chip removal element, wherein FIGS. 7A and 7B are schematic diagrams obtained from different viewing angles.

FIGS. 8A-8B are schematic diagrams of the repairing device of the electrical discharge machining apparatus of the invention provided with a scrolling mechanism, wherein FIGS. 8A and 8B are schematic diagrams obtained from different viewing angles.

FIGS. 9A-9C are flow diagrams of the repairing device of the electrical discharge machining apparatus of the invention repairing the electrode by means of displacement, wherein FIGS. 9A, 9B and 9C are schematic diagrams of flow steps respectively.

FIGS. 10A-10B are schematic diagrams of the repairing device of the electrical discharge machining apparatus of the invention performing a slitting procedure with a slitting element, wherein FIGS. 10A and 10B are schematic diagrams obtained from different viewing angles.

FIGS. 11A-11B are schematic diagrams of the repairing device of the electrical discharge machining apparatus of the invention performing the electrical discharge machining procedure with the slitting element, wherein FIGS. 11A and 11B are schematic diagrams obtained from different viewing angles.

FIGS. 12A-12B are schematic diagrams of the repairing device of the electrical discharge machining apparatus of the invention provided with an adjusting element, wherein FIGS. 12A and 12B are schematic diagrams obtained from different viewing angles.

FIGS. 13A-13B are schematic diagrams of the repairing device of the electrical discharge machining apparatus of the invention provided with an orientation correction element, wherein FIGS. 13A and 13B are schematic diagrams obtained from different viewing angles.

FIG. 14 is a schematic diagram of scrolling the electrode by a jig of the electrical discharge machining apparatus of the invention.

FIG. 15 is a schematic diagram of the electrical discharge machining apparatus of the invention provided with a tension control module.

FIGS. 16A-16B are schematic diagrams of the electrical discharge machining apparatus of the invention provided with a slag removal unit, wherein FIGS. 16A and 16B are schematic diagrams of different implementation examples.

### DETAILED DESCRIPTION OF THE INVENTION

In order to understand the technical features, content and advantages of the invention and its achievable efficacies, the invention is described below in detail in conjunction with the figures, and in the form of embodiments, the figures used herein are only for a purpose of schematically supplementing the specification, and may not be true proportions and precise configurations after implementation of the invention; and therefore, relationship between the proportions and configurations of the attached figures should not be interpreted to limit the scope of the claims of the invention in actual implementation. In addition, in order to facilitate understanding, the same elements in the following embodiments are indicated by the same referenced numbers. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present invention will be defined below or in other parts of the descriptions as an extra guidance for those skilled in the art to understand the descriptions of the present invention.

The terms such as “first”, “second”, “third” used in the descriptions are not indicating an order or sequence, and are not intending to limit the scope of the present invention. They are used only for differentiation of components or operations described by the same terms.

Moreover, the terms “comprising”, “including”, “having”, and “with” used in the descriptions are all open terms and have the meaning of “comprising but not limited to”.

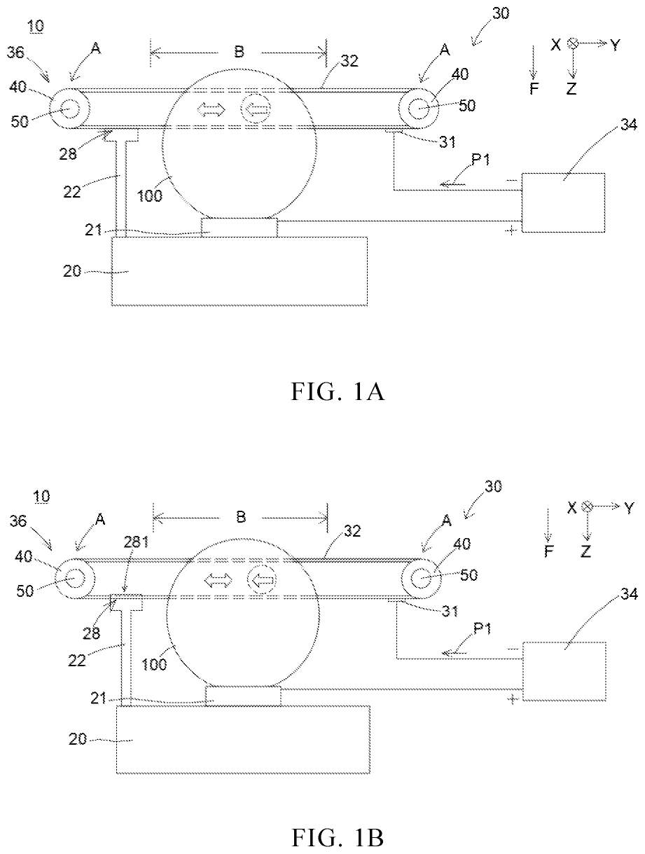

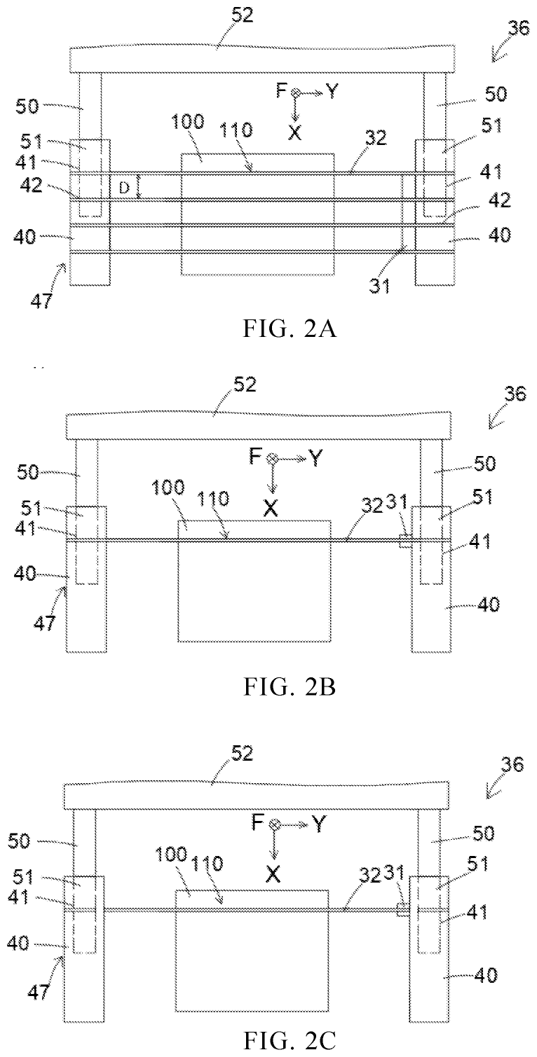

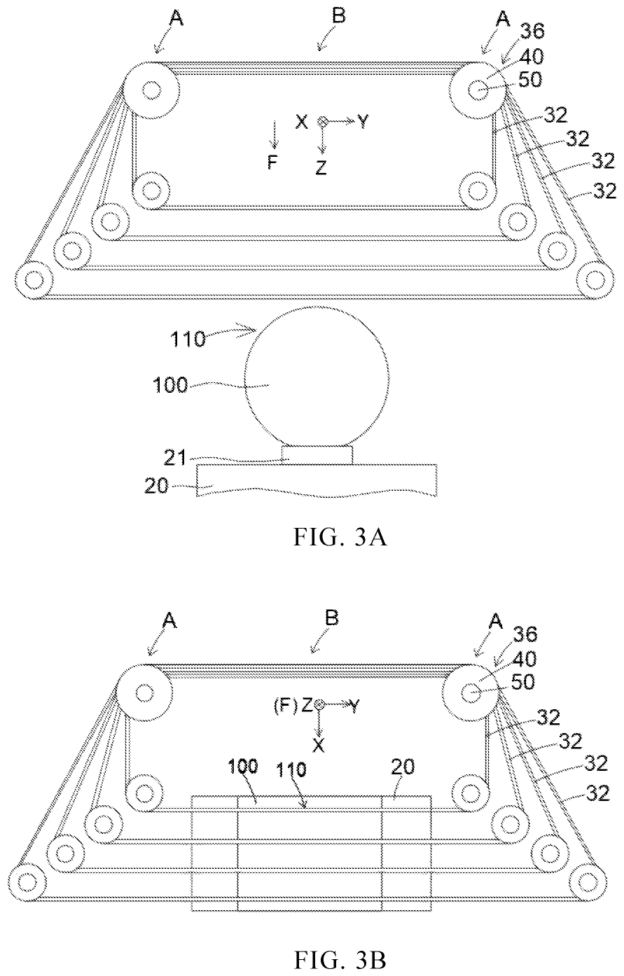

FIGS. 1A-1B are front views of an electrical discharge machining apparatus of the invention, wherein FIGS. 1A and 1B are schematic diagrams of different implementation examples. FIGS. 2A-2C are top views of partial structures of the electrical discharge machining apparatus of the invention, multiple electrodes in a surrounding design (i.e., encircle design) are shown in FIG. 2A, one electrode in a surrounding design is shown in FIG. 2B, and one electrode in a bridging design (i.e., interconnect design) is shown in FIG. 2C. FIGS. 3A-3B are schematic diagrams of configuration of a jig of the invention using a plurality of carrying members to arrange the electrodes in parallel to one another, wherein FIG. 3A shows multiple electrodes sequentially performing an electrical discharge machining procedure on single machined target area, and FIG. 3B shows multiple electrodes performing the electrical discharge machining procedure on multiple machined target areas simultaneously.

Please refer to FIGS. 1A-1B to FIGS. 3A-3B, an electrical discharge machining apparatus 10 of the invention at least comprises a carrier platform 20 and an electrical discharge machining unit 30. The carrier platform 20 is used to carry at least one to-be-machined object 100. Two ends of an electrode 32 of the electrical discharge machining unit 30 are respectively bridged (as shown in FIG. 2C) or surrounded (as shown in FIG. 1A, FIG. 1B, FIG. 2A and FIG. 2B) on two jigs 36, so that the electrode 32 is suspended in an electrical discharge section B, i.e. the electrode 32 is in the suspended state in the electrical discharge section B). The electrode 32 of the electrical discharge machining unit 30 extends along a second direction Y, so that the electrode 32 is parallel to the second direction Y in the electrical discharge section B, wherein the second direction Y is perpendicular to a first direction X and a machining direction F respectively. The electrode 32 located in the electrical discharge section B (that is, the electrical discharge section B of the electrode 32) and a machined target area 110 of the to-be-machined object 100 move in a reciprocating or cyclical manner relative to each other (for example, along a direction of a hollow double or single arrow shown in FIGS. 1A-1B (the second direction Y) to produce relative displacement) to perform an electrical discharge machining procedure on the machined target area 110 of the to-be-machined object 100 on the carrier platform 20 with the electrode 32 along the machining direction F, for example the electrical discharge machining procedure of cutting and/or electrical discharge grinding (EDG) is performed sequentially or simultaneously on the machined target area 110 of the to-be-machined object 100. A power supply unit 34 of the electrical discharge machining unit 30 provides a first power source P1 to the electrode 32 and the to-be-machined object 100 during the electrical discharge machining procedure in order to apply an electrical discharge energy to the machined target area 110 of the to-be-machined object 100 through the electrode 32 located in the electrical discharge section B. In implementation modes shown in FIGS. 1A-1B to 3A-3B, an axis of the jig 36 is perpendicular to the machining direction F, for example. However, the invention is not limited thereto, in other feasible implementation modes, the axis of the jig 36 can also be parallel to the machining direction F, for example. The to-be-machined object 100 can be any conductive or semiconductive structure, such as an ingot or a wafer. The carrier platform 20 of the invention can be a fixed-position carrier platform, or a movable or rotatable motional carrier platform, wherein the invention is illustrated by taking the carrier platform 20 as a working platform with a carrier plate 21, but the invention is not limited thereto, the carrier platform 20 of the invention can also optionally omit the carrier plate 21 or replace the carrier plate 21 with an adhesive layer (such as conductive glue). In order to avoid chattering phenomenon generated by the electrode 32 during the electrical discharge machining procedure, the electrical discharge machining apparatus 10 of the invention optionally has a stabilizing member 22, wherein the stabilizing member 22 is, for example, disposed on the carrier platform 20, and for example, supported between two sides A of the electrode 32, a shape of the stabilizing member 22 is not particularly limited, as long as it is capable of reducing chattering of the electrode 32, it is applicable to the invention. For example, a contact surface 28 where the stabilizing member 22 is in contact with the electrode 32 can be, for example, a plane (as shown in FIG. 1A), for example, supporting the electrode 32 in a suspended state, chattering phenomenon can be reduced, or the contact surface 28 where the stabilizing member 22 is in contact with the electrode 32 can optionally have a guide groove 281 (as shown in FIG. 1). The guide groove 281 can not only support the suspended electrode 32, but also stabilize the electrode 32 and provide a guiding effect when the electrode 32 reciprocates relative to the to-be-machined object 100. In addition, the stabilizing member 22 can also optionally be designed with a height retractable structure, so that a height of the contact surface 28 where the stabilizing member 22 is in contact with the electrode 32 can be changed.

As shown in FIGS. 1A-1B to 3A-3B, the electrical discharge machining unit 30 comprises the at least one electrode 32, the power supply unit 34 and the jig 36. A quantity of the at least one electrode 32 can be, for example, one (as shown in FIG. 2B and FIG. 2C) or more than one, which is/are used to perform the electrical discharge machining procedure on the machined target area 110 or the machined target areas 110 (as shown in FIG. 2A and FIG. 3B) defined on the to-be-machined object 100. FIGS. 3A-3B are schematic diagrams of two implementation modes of the invention in which the electrodes 32 are arranged in parallel to one another through a plurality of carrying members, wherein FIG. 3A shows that the electrodes 32 are arranged in parallel to one another along the machining direction F, thereby the electrodes 32 are capable of sequentially performing the electrical discharge machining procedure on the machined target area 110, and FIG. 3B shows that the electrodes 32 are arranged in parallel to one another along the first direction X, thereby the electrodes 32 are capable of performing the electrical discharge machining procedure on the machined target areas 110 simultaneously. Taking the electrodes 32 in the electrical discharge section B extending along the second direction Y as an example, the electrodes 32 are, for example, linear or plate-shaped conductive structures parallel to one another in the first direction X (as shown in FIG. 3B) and/or the machining direction F (as shown in FIG. 3A), such as conductive wires or foil, wherein the machining direction F is parallel to a third direction Z and perpendicular to the first direction X. A quantity of the electrodes 32 is optionally determined according to actual requirements. A distance between the electrodes 32 corresponds to a cutting or thinning thickness of the to-be-machined object 100. Transverse cross-sections of the electrodes 32 can be any shapes that are the same or different, such as linear or plate-shape (or sheet-shape), or any symmetrical (such as circular, square, or rectangular) or asymmetrical shapes. The power supply unit 34 is electrically connected to the electrodes 32 and the to-be-machined object 100 respectively via electrical contacts 31. Wherein the power supply unit 34 can be a power output or a plurality of power outputs for supplying the first power source P1. The power supply unit 34 can also be electrically connected to the electrodes 32 in series or in parallel, as long as an electrical discharge energy can be applied to the machined target area 110 of the to-be-machined object 100 through the electrodes 32, it is applicable to the invention.

A material of the electrodes 32, for example, can be selected from a group consisting of copper, brass, molybdenum, tungsten, graphite, steel, aluminum and zinc. A thickness of the electrical discharge electrodes 32 is approximately less than 300 μm, and a thickness range is preferably approximately 30 μm to approximately 300 μm. However, it should be noted that although the invention is illustrated with the electrodes 32, it is not limited thereto. The electrode 32, as shown in FIG. 2C, also belongs to a scope of protection claimed by the invention. Since a person having ordinary skill in the art to which the invention pertains should understand how to apply the technical means of the invention to a single electrode or a plurality of electrodes based on the disclosure of the invention and the conventional techniques, no further details are provided herein. When the electrodes 32 are arranged parallel to one another in the machining direction F, the electrodes 32 will sequentially perform cutting or electrical discharge grinding on the machined target area 110 of the to-be-machined object 100 along the machining direction F, and the electrode 32 located behind will pass a position again that the electrode 32 located in front has already passed. In other words, taking the machining direction F from top to bottom as an example, even if the front electrode 32 (such as the electrode below) is disconnected, the rear electrode 32 (such as the electrode above) can still replace the front electrode 32 to apply an electrical discharge energy to the machined target area 110 of the to-be-machined object 100. Therefore, the invention is capable of avoiding adverse effects such as process interruption caused by disconnection of the electrode 32 through electrode replacement function.

Please refer to FIGS. 1A-1B to 2A-2C, the jig 36 is optionally formed by correspondingly assembling at least two carrying members 40 and at least two holding members 50 respectively. The two sides A of the electrode 32 movably or fixedly abut against the two carrying members 40 respectively, so that the electrical discharge section B of the electrode 32 is suspended, wherein the two carrying members 40 are separated from each other by a distance. Dimensions of the two carrying members 40 and a height of the electrode 32 the two carrying members 40 carry are not particularly limited to be the same or different, as long as the electrical discharge section B of the electrode 32 can be suspended, it is applicable to the invention. The holding member 50 is optionally detachably or fixedly assembling with the carrying member 40 stably. The holding member 50 is disposed on a seat body 52, wherein the seat body 52 can be a structure that is capable of fixing a position of the holding member 50, or the seat body 52 is a motion mechanism capable of moving or rotating the holding member 50 to correspondingly drive the carrying member 40 to move or rotate. Therefore, the electrical discharge section B of the electrode 32 is capable of reciprocating leftward and rightward. The invention is not limited to the carrier platform 20 driving the to-be-machined object 100 to move toward the electrode 32 of the electrical discharge machining unit 30, or the seat body 52 driving the electrode 32 to move toward the to-be-machined object 100, as long as the electrical discharge machining unit 30 and the to-be-machined object 100 on the carrier platform 20 are capable of moving relatively along the machining direction F, it is applicable to the invention. Taking the seat body 52 as a motion mechanism as an example, the motion mechanism can be any moving mechanism capable of reciprocating leftward and rightward, such as a sliding mechanism, or any rotating mechanism capable of performing reciprocating rotation or cyclical rotation, such as a motor, used to correspondingly drive the holding member 50 to move or rotate. Thereby, the carrying member 40 and the holding member 50 are capable of optionally moving reciprocatingly or cyclically together with the electrode 32, so that the electrode 32 is capable of applying an electrical discharge energy to the to-be-machined object 100 in the electrical discharge section B. In order to enable the electrode 32 to have better adherence to the carrying member 40, an edge of the carrying member 40 is optionally provided with a lead angle 47, as shown in FIGS. 2A-2C.

In other feasible embodiments, the electrical discharge machining unit 30 of the invention can, for example, rotate two or more than two of the carrying members 40 in a reciprocating or cyclical manner in order to drive the electrical discharge sections B of the electrodes 32 to move in a reciprocating or cyclical manner. Two examples of connection configuration of the carrying member 40 and the electrode 32 can be implemented as shown in FIGS. 3A and 3B, each of the electrodes 32 respectively surrounds the four carrying members 40, wherein FIG. 3A and FIG. 3B are different implementation examples, FIG. 3A shows that the electrodes 32 are arranged in parallel to one another along the machining direction F, thereby the electrodes 32 are capable of sequentially performing the electrical discharge machining procedure on the machined target area 110; and FIG. 3B shows that the electrodes 32 are arranged in parallel to one another along the first direction X, thereby the electrodes 32 are capable of simultaneously performing the electrical discharge machining procedure on the machined target areas 110. The electrodes 32 share the two carrying members 40 among the four carrying members 40, so the two sides A of the electrodes 32 are in contact with one another to present a stacked state and movably abut against the two shared carrying members 40. The rest of the carrying members 40 are disposed in pairs at different vertical heights or horizontal positions, so that the electrodes 32 are separately arranged in parallel to one another in the machining direction F (as shown in FIG. 3A) or in the first direction X (as shown in FIG. 3B) by a distance. Thereby, when the carrying members 40 rotate reciprocatingly or cyclically, the electrical discharge sections B of the electrodes 32 displace in the second direction Y relative to the to-be-machined object 100. Wherein the shared carrying members 40, for example, synchronously rotate in a reciprocating or cyclical manner.

In short, the invention uses a variety of ways to make the electrical discharge sections B of the electrodes 32 and the machined target areas 110 of the to-be-machined object 100 move relative to one another along the machining direction F. A first way is that the to-be-machined object 100 moves along the machining direction F and the electrodes 32 are motionlessly fixed in the machining direction F. A second way is that the electrodes 32 move along the machining direction F and the to-be-machined object 100 is motionlessly fixed in the machining direction F. A third way is that the electrodes 32 and the to-be-machined object 100 move along a direction opposite to the machining direction F.

By the same token, the invention further uses a variety of ways to make the electrical discharge sections B of the electrodes 32 and the machined target areas 110 of the to-be-machined object 100 move relative to one another along the second direction Y. A first way is that the to-be-machined object 100 moves along the second direction Y and the electrodes 32 are motionlessly fixed in the second direction Y. A second way is that the electrodes 32 move along the second direction Y and the to-be-machined object 100 is motionlessly fixed in the second direction Y. A third way is that the electrodes 32 and the to-be-machined object 100 move along a direction opposite to the second direction Y. Wherein, in the second way of relatively moving the electrical discharge sections B and the machined target areas 110 along the second direction Y, the invention is capable of also, for example, using the jig 36 to scroll the electrodes 32 in a reciprocating or cyclical manner, so that the electrodes 32 move leftward and rightward (reciprocating manner) or continuously (cyclical manner), or the electrodes 32 are fixed on the jig 36, and the seat body 52 moves the jig 36 leftward and rightward (reciprocating manner) along the second direction Y as shown in the figures in order to move the electrodes 32 indirectly.

However, it should be noted that although the invention lists the above-mentioned various moving modes for performing the electrical discharge machining procedure, the moving modes are not intended to limit the invention. For example, a scope of protection claimed by the invention can also cover that the to-be-machined object 100 moves along the machining direction F and the electrodes 32 are motionlessly fixed in the machining direction F and the second direction Y, or the electrodes 32 move along the machining direction F and the to-be-machined object 100 is motionlessly fixed in the machining direction F and the second direction Y. That is to say, any moving mode belongs to a scope of protection claimed by the invention as long as it is capable of carrying out the electrical discharge machining procedure.

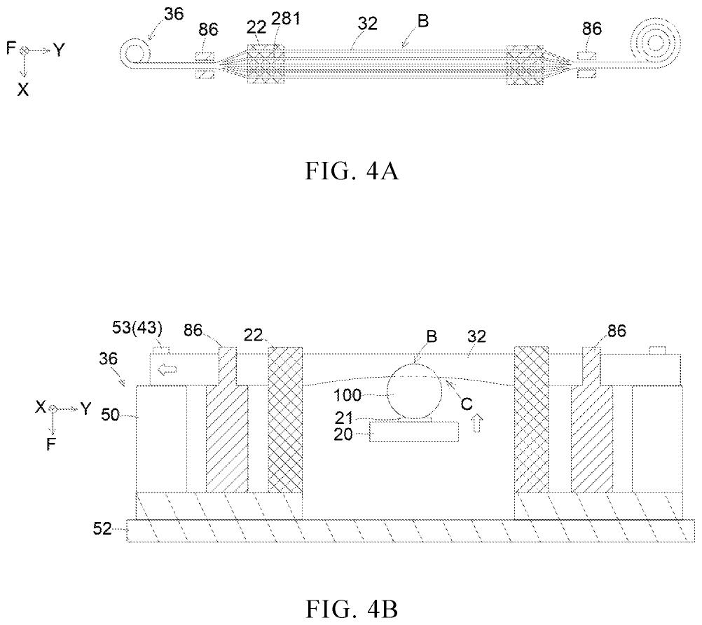

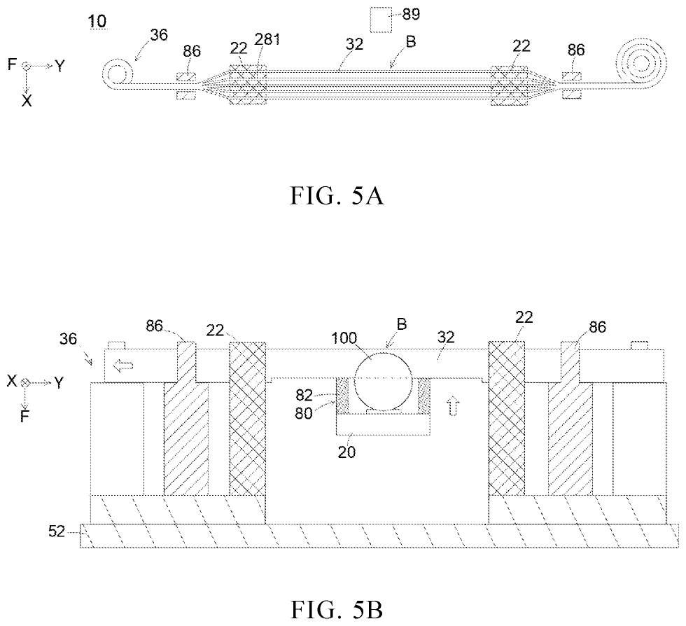

As shown in FIGS. 4A and 4B, because in the electrical discharge machining procedure, an appearance (such as bottom surface) of the electrode 32 easily produces a phenomenon of inconsistent wear degree (that is, an area to be corrected defined by the invention), resulting in short-circuit problem in the electrical discharge machining procedure. Although there are quite a few reasons (such as external reasons and internal reasons) that can cause the electrode 32 to have inconsistent wear degree, in order to more thoroughly solve the short-circuit problem caused by the above-mentioned inconsistent wear degree, as shown in FIGS. 5A and 5B, one feature of the electrical discharge machining apparatus 10 of the invention is that a repairing device 80 is provided for repairing or correcting the electrode 32 that apparently has the area to be corrected. The repairing device 80 performs a repairing procedure on the electrode 32, for example, repairs or corrects the appearance of the electrode 32 while the electrode 32 performs the electrical discharge machining procedure on the machined target area 110. However, the invention is not limited thereto, the repairing device 80 can also, for example, perform the repairing procedure on the electrode 32 before or after the electrode 32 performs the electrical discharge machining procedure on the machined target area 110. That is, no matter when the repairing device 80 performs the repairing procedure on the electrode 32, as long as the appearance of the electrode 32 is corrected to be capable of electrically discharging stably, it belongs to a scope of protection claimed by the invention. Although FIGS. 4A and 4B are schematic diagrams obtained from different viewing angles, in order to make the figures simple, FIG. 4A only shows partial structures of each component, and FIG. 4B only shows components to be specifically illustrated, and FIGS. 5A-5B are generally presented in a manner the same as other similar figures, so details are not repeated herein. In addition, in implementation modes shown in FIGS. 4A-4B to 16A-16B, an axis of the jig 36 is parallel to the machining direction F.

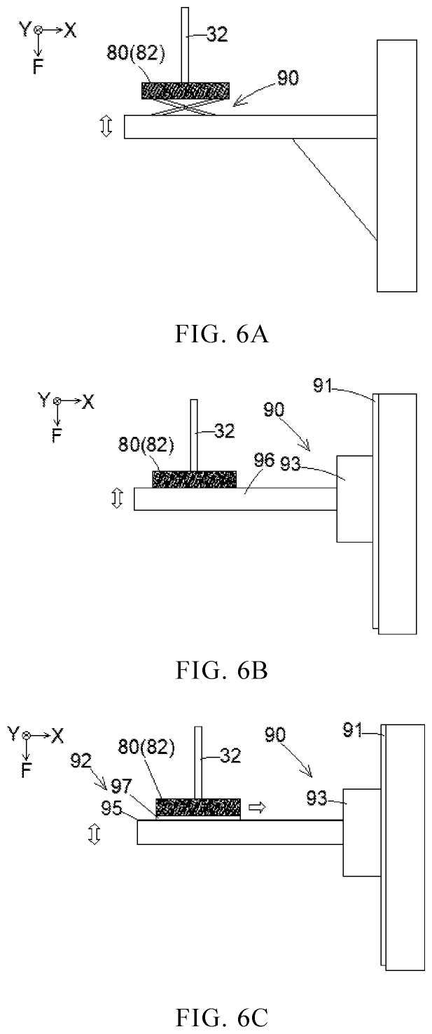

For example, as shown in FIGS. 5A and 5B, the repairing device 80 of the invention can, for example, comprise a dressing element 82 used to correct the appearance of the electrode 32 through relative displacements between the dressing element 82 and the electrode 32 during the repairing procedure. The dressing element 82 of the invention is, for example, a laser source, a cutting tool or a grinding element, which can be, for example, fixedly or movably disposed on the carrier platform 20 or the seat body 52, or independently disposed in the electrical discharge machining apparatus 10 (FIGS. 6A to 6C), but the invention is not limited thereto, any technical means that is capable of changing the appearance of the electrode 32, it belongs to a scope of protection claimed by the invention. Moreover, as long as the dressing element 82 of the repairing device 80 is capable of repairing the appearance of the electrical discharge section B of the electrode 32, such as making its wear degree consistent or obtaining a desired appearance of the electrode 32, no matter whether the repairing device 80 of the invention performs the repairing procedure on the appearance of the electrode 32 in real-time, regularly, non-regularly, periodically or non-periodically, it belongs to a scope of protection claimed by the invention.

The repairing device 80 of the invention is capable of optionally repairing the appearance of the electrode 32 in a quantitative adjustment manner according to a wear rate of the electrode 32 (for example, theoretical or measured wear rate) and a feed speed of the electrical discharge machining procedure, wherein the repairing device 80 can, for example, correct the appearance of the electrode 32 in a quantitative adjustment manner along the machining direction F (for example, move the dressing element 82 relative to the to-be-machined object 100 by a predetermined distance along the machining direction F at a predetermined speed), or correct the appearance of the electrode 32 in a quantitative adjustment manner along the second direction Y (for example, move the electrode 32 relative to the to-be-machined object 100 by a predetermined length along the second direction Y at a predetermined speed). Alternatively, the repairing device 80 is capable of optionally repairing the appearance of the electrode 32 in a dynamic adjustment manner according to a real-time state of the electrode 32. For example, the invention is further capable of optionally knowing real-time states of the electrode 32 such as a real-time wear degree through a detection element 89. Wherein the detection element 89 is, for example, an electrical discharge change detection element, or a photoelectric detection element or an image detection element provided with a light emitter and a light receiver, and is used to know a wear degree of the electrical discharge section B of the electrode 32 through light interruption or light intensity change.

In addition, the dressing element 82 can be optionally designed as a lifting type, so that a height can be changed according to a wear rate of the electrode 32 and a feed speed of the electrical discharge machining procedure, thereby a wear degree of the electrical discharge section B of the electrode 32 is consistent. For example, assuming that a moving speed of the carrier platform 20 (a feed speed of the electrical discharge machining procedure) is d length per minute, and a theoretical wear rate of the electrode 32 is 0.1 d length per minute, if the dressing element 82 is disposed on the carrier platform 20, when the electrical discharge machining procedure is performed, the dressing element 82 of the invention can be attached to a bottom surface of the electrode 32, and the 0.1 d length can be extended toward a direction of the electrode 32 every minute through the lifting design, so that the electrical discharge section B of the electrode 32 is capable of reaching a predetermined wear degree during the entire electrical discharge machining procedure. By the same token, the dressing element 82 of the invention can also be dynamically adjusted to lift and descend to a required height according to real-time states of the electrode 32, such as a real-time wear degree, so as to correct the appearance of the electrode 32 in real time. For example, the dressing element 82 of the invention can be, for example, a retractable design to lift or lower to a height, or the dressing element 82 of the invention can also be, for example, disposed on a lifting mechanism 90, as shown in FIGS. 6A to 6C, thereby a height can be lifted and lowered according to requirements of the repairing procedure, and a feed speed of the dressing element 82 can be controlled. The lifting mechanism 90 can be, for example, a slide type lifting platform as shown in FIGS. 6B and 6C, which has a sliding platform 93 that can be lifted and lowered along a rail 91, and the dressing element 82 is, for example, disposed on the sliding platform 93 through a carrier platform carrying a wafer or through a carrier frame 96. Alternatively, the lifting mechanism 90 can be, for example, a spring type (or retractable type) lifting platform as shown in FIG. 6A. Moreover, the lifting mechanism 90 of the invention is not limited to manual or automatic design, as long as the dressing element 82 can be lifted and lowered, it belongs to a scope of protection claimed by the invention. In addition, the dressing element 82 can also be, for example, disposed on the lifting mechanism 90 via a translation mechanism 92, as shown in FIG. 6C, which has a sliding platform 97 capable of translating along a rail 95, so that when performing the repairing procedure, the translation mechanism 92 can be optionally used to move the dressing element 82 to reach below the electrode 32 along the rail 95, and then move out after the repairing procedure is completed. Although the invention is illustrated with structures shown in FIGS. 6A-6C as an example, the invention is not limited thereto, any design capable of moving a position of the dressing element 82 and displacing relative to the electrode 32, or moving a position of the electrode 32 and displacing relative to the dressing element 82, it belongs to a scope of protection claimed by the invention.

Taking the dressing element 82 as a laser source or a cutter as an example, the dressing element 82 can be located on a bottom side or a side of the electrode 32. When a relative displacement occurs between the dressing element 82 and the electrode 32, a laser light of the laser source or a blade of the cutter can be used to cut off a thickness of a bottom of the electrode 32 partially, so that the appearance of the electrode 32 that originally has inconsistent wear degree on the electrical discharge section B of the electrode 32 becomes level. Taking the dressing element 82 as a grinding element as an example, the dressing element 82 can be located on the bottom side of the electrode 32, for example. When a relative displacement occurs between the dressing element 82 and the electrode 32, grinding composition of the grinding element can be used to remove a thickness of the bottom of the electrode 32 partially, so that the appearance of the electrode 32 that originally has inconsistent wear degree becomes level, as shown in FIG. 5B and FIGS. 6A to 6C.

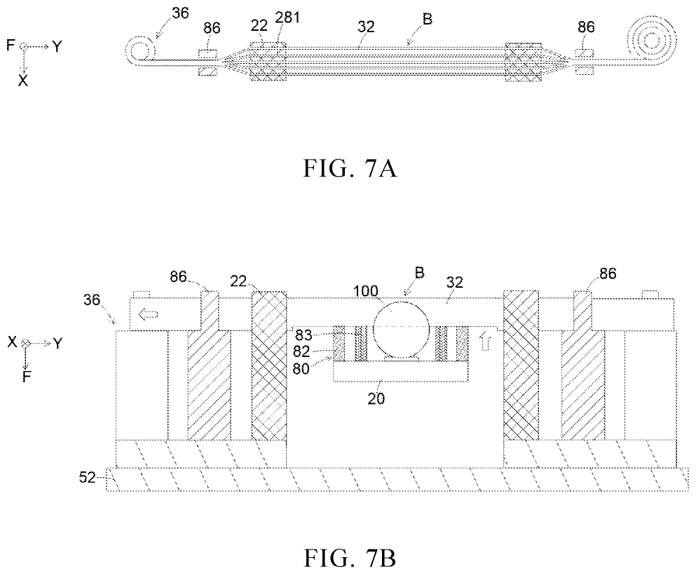

In addition, when the repairing device 80 is performing the repairing procedure, substances such as cutting chips can remain on the dressing element 82 or the electrode 32. Therefore, as shown in FIGS. 7A and 7B, the repairing device 80 of the invention further optionally comprises a chip removal element 83, that can be, for example, a cleaning utensil such as sponge or scraper or ultrasonic element, and for example, can be disposed on the carrier platform 20, the seat body 52 or other elements used to abut against the bottom of the electrode 32 and/or a top of the dressing element 82, thereby, when the repairing device 80 repairs or corrects the appearance of the electrode 32 with the dressing element 82 through relative displacements between the dressing element 82 and the electrode 32, the chip removal element 83 can also simultaneously remove cutting chips and other substances remaining on the dressing element 82 and/or the electrode 32. Disposition of the chip removal element 83 is not limited to fixed or movable design, as long as it is capable of achieving cleaning and removing residual cutting chips and other substances, it belongs to a scope of protection claimed by the invention. In addition, the chip removal element 83 of the invention can also optionally be an ultrasonic element, and for example, can be disposed on the dressing element 82, the lifting mechanism 90 or the translation mechanism 92 shown in FIGS. 6A-6C, thereby increasing a dressing rate and providing a chip removal effect to reduce abrasive or grinding paper stuck with residual chips or the electrode 32 adhered with grinding residues.

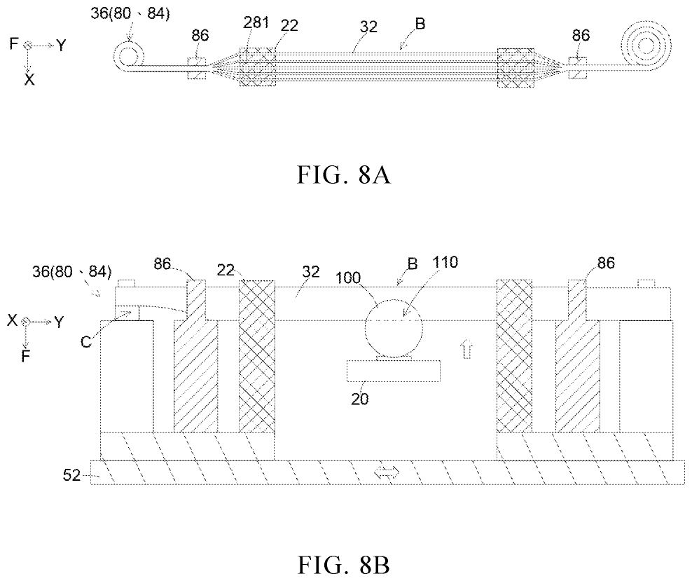

In addition, the repairing device 80 of the invention is further capable of moving an area C of the electrode 32 away where there is inconsistent wear degree, for example, by shifting, so that the area C is avoided from being used as the electrical discharge section B. As shown in FIG. 8A and FIG. 8B, the repairing device 80 of the invention can optionally comprise a scrolling mechanism 84, for example. Wherein when the area to be corrected appears in the appearance of the electrode 32 in the electrical discharge section B, for example, when there is an inconsistent wear phenomenon or even fracture phenomenon, the scrolling mechanism 84 of the repairing device 80 can at least scroll the electrode 32 with the area to be corrected appeared on the appearance, for example, clockwise or counterclockwise, or move the electrode 32 with the area to be corrected (the area C) appeared on the appearance to keep away (or stagger) from the machined target area 110 of the to-be-machined object 100, for example, scroll the broken electrode 32 to an outer side of the stabilizing member 22, so that other normal areas of the electrode 32 can be used as the electrical discharge section B, and an interference generated by the broken electrode 32 can be blocked. In the invention, for example, the holding member 50 with a scrolling design and the jig 36 of the carrying member 40 are used as the scrolling mechanism 84. The scrolling mechanism 84 of the invention is not limited to manual or automatic design, and a structural design is not limited to the above examples, as long as the area with inconsistent wear degree of the electrode 32 can be moved away to avoid being used as the electrical discharge section B, it belongs to a scope of protection claimed by the invention.

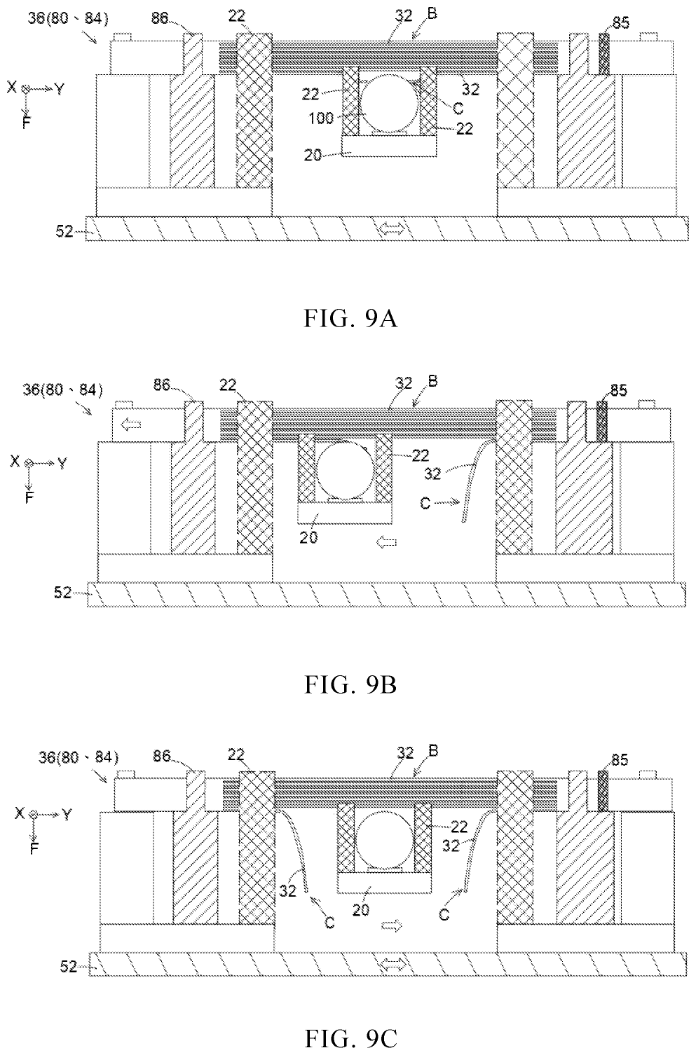

For example, as shown in FIG. 9A to FIG. 9C, during the electrical discharge machining procedure (that is, before completion of the electrical discharge machining procedure), if fracture phenomenon shown in FIG. 9A appears in the appearance of the lowermost electrode 32 at the electrical discharge section B, the invention is capable of optionally making the to-be-machined object 100 actively move a position (for example, move leftward, as shown in FIG. 9B, so that the rightward broken electrode 32 breaks away from (avoids) the to-be-machined object 100) by shifting. Then, for example, move rightward, so that the broken electrode 32 on the left breaks away from (avoids) the to-be-machined object 100. At this time, the broken electrode 32 can also be optionally sucked or stuck, or even cut off the broken electrode 32, as long as the broken electrode 32 can break away from the to-be-machined object 100. Then, as shown in FIG. 9C, the to-be-machined object 100 can be moved to a previous electrical discharge machining position, and the other unbroken electrodes 32 can be used to continue to perform the electrical discharge machining procedure on the to-be-machined object 100 that has not been completed until the entire electrical discharge machining procedure is completed. Therefore, the invention is capable of avoiding completely interrupting an entire electrical discharge machining apparatus and an electrical discharge machining procedure in the conventional manufacturing process, and manually adjusting the electrode 32 before continuing the unfinished electrical discharge machining procedure. By the same token, the invention is further capable of scrolling the broken electrode 32 leftward and/or rightward to reach the outer side of the stabilizing member 22, for example, by means of the jig 36 (or the scrolling mechanism 84 of the repairing device 80), as shown in FIG. 9C, and continuously performing the previously unfinished electrical discharge machining procedure on the to-be-machined object 100 with the other unbroken electrodes 32 until the entire electrical discharge machining procedure is completed. In implementation examples shown in FIG. 9A to FIG. 9C, the invention is based on an example that the stabilizing member 22 is located on the carrier platform 20 and, for example, is located on two sides of the to-be-machined object 100, so that after the electrode 32 is moved to the outer side of the stabilizing member 22, the electrode 32 cannot enter an inner side of the stabilizing member 22, and therefore the electrodes 32 having a fracture phenomenon can be easily ruled out. By the same token, the invention is not limited thereto. The stabilizing member 22 of the invention can also be optionally located on the seat body 52, or the stabilizing member 22 is located on the carrier platform 20 and the seat body 52 at the same time, which is also capable of achieving an effect of ruling out the broken electrodes 32 by shifting.

In short, the repairing device 80 of the invention is capable of, for example, making a wear degree of the electrical discharge section B of the electrode 32 consistent by removing, so as to provide an effect of electrical discharge stabilization. Alternatively, the repairing device 80 of the invention is capable of removing the area C where a wear degree of the electrode 32 is inconsistent, for example, by shifting, so as to prevent the area C from being used as the electrical discharge section B. However, the invention is not limited thereto, and the repairing device 80 of the invention is capable of also, for example, combining the above two methods or adopting any feasible method to achieve an effect of repairing the appearance of the electrode 32. In other words, no matter what technical means the repairing device 80 uses to perform the repairing procedure on the electrode 32, as long as it is capable of solving short-circuit problem caused by inconsistent wear degree, it belongs to a scope of protection claimed by the invention.

The repairing device 80 of the invention can optionally further comprise at least one clamping element 86 (as shown in FIGS. 4A-4B to FIGS. 9A-9C) to be fixedly disposed on the seat body 52 or other components of the electrical discharge machining apparatus 10 for optionally clamping at least one side, for example, two sides, of the electrical discharge section B of the electrode 32. An implementation mode of the clamping element 86 is, for example, a structure with a vise, but it is not limited thereto. For example, when the invention moves the seat body 52 leftward and rightward (along the second direction Y) to drive the electrode 32 to displace leftward and rightward synchronously relative to the to-be-machined object 100 via the jig 36, the clamping element 86 is capable of optionally clamping the electrode 32 (as shown in FIG. 8B) so that the electrode 32 can carry out the electrical discharge machining procedure. Besides the clamping element 86 can be used to optionally fix a position of the electrode 32, but also prevent the electrode 32 from loosening due to being pulled during the electrical discharge machining procedure, resulting in a decrease in a tension of the electrode 32 to cause adverse effects on the electrical discharge machining procedure. By the same token, when the jig 36 needs to scroll the electrode 32 (such as performing the repairing procedure or moving the electrode 32 to perform the electrical discharge machining procedure), the clamping element 86 can release the electrode 32.

As shown in FIGS. 5A-5B to 9A-9C, since in the electrical discharge machining procedure, the electrical discharge section B of the electrode 32 advances along the machining direction F to apply an electrical discharge energy to the machined target area 110 of the to-be-machined object 100, and the electrical discharge section B of the electrode 32 and the machined target area 110 of the to-be-machined object 100 move relatively along the second direction Y at the same time; therefore, in order to avoid chattering phenomenon of the electrode 32 during the electrical discharge machining procedure, the electrical discharge machining apparatus 10 of the invention is optionally provided with the stabilizing member 22 disposed on the seat body 52 or other components of the electrical discharge machining apparatus 10, such as on the carrier platform 20. A disposing position of the stabilizing member 22 is, for example, located on at least one side or an outer side of the electrical discharge section B of the electrode 32. There is no particular limitation on a shape of the stabilizing member 22, as long as it is capable of reducing chattering of the electrode 32, it is applicable to the invention. For example, the stabilizing member 22 has the guide grooves 281, a size of the guide groove 281, such as depth or width, is sufficient to movably accommodate the electrode 32. A quantity of the guide grooves 281 corresponds to the electrodes 32, so that a spacing between the electrodes 32 can be maintained and oscillation along the first direction X can be reduced for effectively stabilizing the electrodes 32 and providing a guiding effect. In addition, the stabilizing member 22 can also be optionally designed with a height retractable structure, so that a height of the guide groove 281 of the stabilizing member 22 in contact with the electrode 32 can be changed according to a depth of a machining groove of the machined target area 110 of the to-be-machined object 100. Wherein a strip structure between the two adjacent guide grooves 281 of the stabilizing member 22 can be used as a separation column to separate the electrodes 32 and make the electrodes 32 parallel to one another. Wherein the electrode 32 abuts against the separation column, for example, the electrode 32 is movable abutted against the separation column, and a position of the separation column is fixed, but the separation column can have a fixed or rolling design, and has a limit groove to serve as a guide column. The separation column can also be optionally made of conductive material, so that the electrode 32 can be electrically connected to the power supply unit 34 through the separation column, that is, the separation column can also be optionally used as the electrical contact 31 in FIGS. 1A-1B. In addition, the separation column can also be made of insulating material to avoid electrical connection between the electrodes 32. Wherein the two carrying members 40, for example, synchronously perform reciprocating or cyclical rotations at a same rotation speed, so reciprocating or cyclical movement speeds of the electrodes 32 along the second direction Y are also the same.

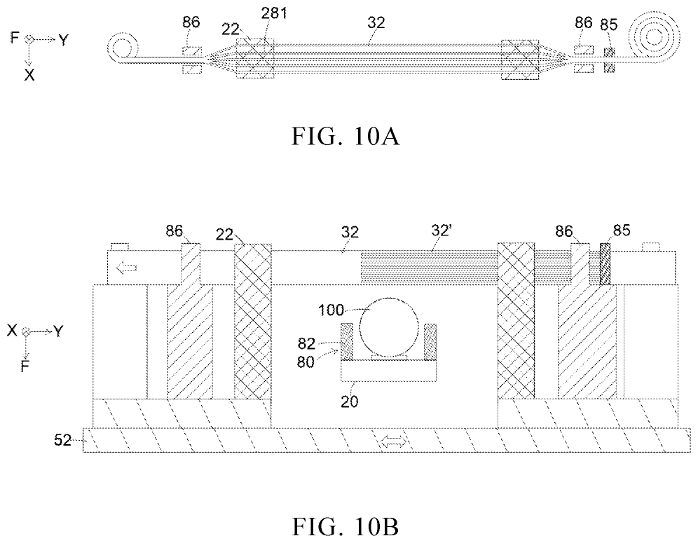

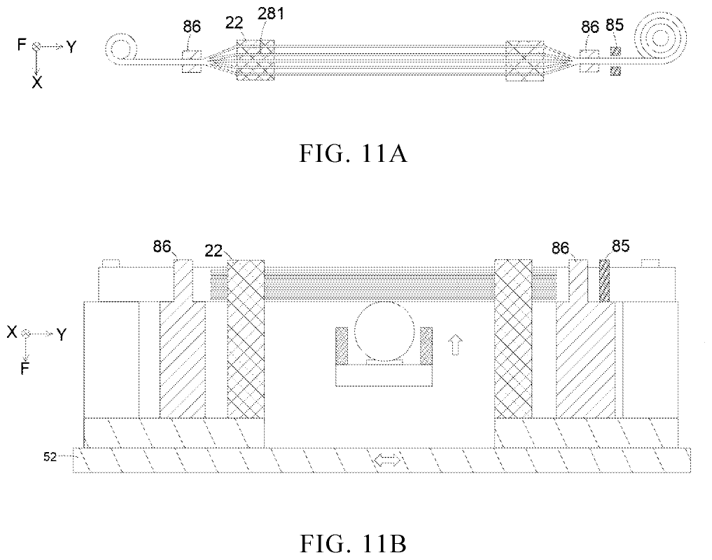

As shown in FIG. 10A, FIG. 10B, FIG. 11A and FIG. 11B, the repairing device 80 of the invention can optionally further comprise at least one slitting element 85, for example, disposed on the seat body 52 or any position of the electrical discharge machining apparatus 10, by relative movements between the slitting element 85 and the plate-shaped electrode 32, the electrode 32 (for example, plate-shaped) can be cut into a plurality of electrode strips 32′ (for example, strip) parallel to one another. The slitting element 85 is, for example, a vise gripper knife with a plurality of blades, but is not limited thereto. For example, if the blades of the vise gripper knife clamp the plate-shaped electrode 32, when relative movements occur between the slitting element 85 and the plate-shaped electrode 32 along the second direction Y (for example, a position of the slitting element 85 is fixed, and the electrode 32 is scrolled by the jig 36 to move horizontally relative to the slitting element 85 in the second direction Y), then the wider plate-shaped electrode 32 will be cut into the electrode strips 32′ with a smaller width. Since a distance between the adjacent blades is equal to a width of the electrode strip 32′, the invention is capable of also changing a distance or a quantity of the blades of the vise gripper knife to adjust a width or a quantity of the electrode strips 32′. In addition, if the invention adopts a method of scrolling the electrode 32 so that the slitting element 85 can carry out a slitting procedure on the electrode 32, since the jig 36 is required to scroll the electrode 32, the clamping element 86 of the invention can optionally temporarily release the electrode 32 when performing the slitting procedure. By the same token, if the invention adopts a method of moving the slitting element 85 to carry out the slitting procedure on the fixed electrode 32, then the clamping element 86 of the invention can optionally clamp the electrode 32 when the slitting element 85 performs the slitting procedure to prevent the electrode 32 from scrolling.

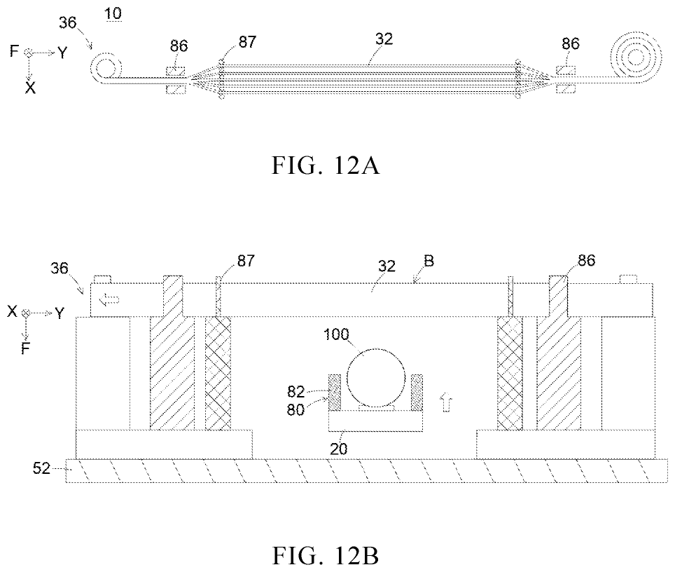

As shown in FIGS. 12A and 12B, the repairing device 80 of the invention can optionally comprise at least one adjusting element 87, such as disposed on the seat body 52 or any position of the electrical discharge machining apparatus 10, the adjusting element 87 is in contact with the electrode 32, through relative movements between the adjusting element 87 and the electrode 32, the electrical discharge section B of the strip-shaped or plate-shaped electrode 32 can be adjusted into a straight line or a vertical shape. If the electrodes 32 are provided, the adjusting element 87 is capable of adjusting the electrodes 32 to be parallel to one another. The adjusting element 87, for example, has a plurality of comb teeth, and the two adjacent comb teeth respectively abut against two sides of each of the electrodes 32, and the adjusting element 87 is, for example, a movable design, for example, moving from one side of the electrical discharge section B to another side (along the second direction Y), but it is not limited thereto. In addition, if the invention performs an adjustment procedure on the electrode 32 with a fixed position by moving the adjusting element 87, the clamping element 86 of the invention can optionally clamp the electrode 32 when the adjusting element 87 performs the adjustment procedure to prevent the electrode 32 from loosening. By the same token, if the invention adopts a method of scrolling the electrode 32 so that the adjusting element 87 can perform the adjustment procedure on the electrode 32, because the jig 36 is required to scroll the electrode 32, so the clamping element 86 of the invention can optionally temporarily release the electrode 32 when the adjusting element 87 performs the adjustment procedure. Wherein the comb teeth of the adjusting element 87 can be used as separation columns to separate the electrodes 32 and make the electrodes 32 parallel to one another.

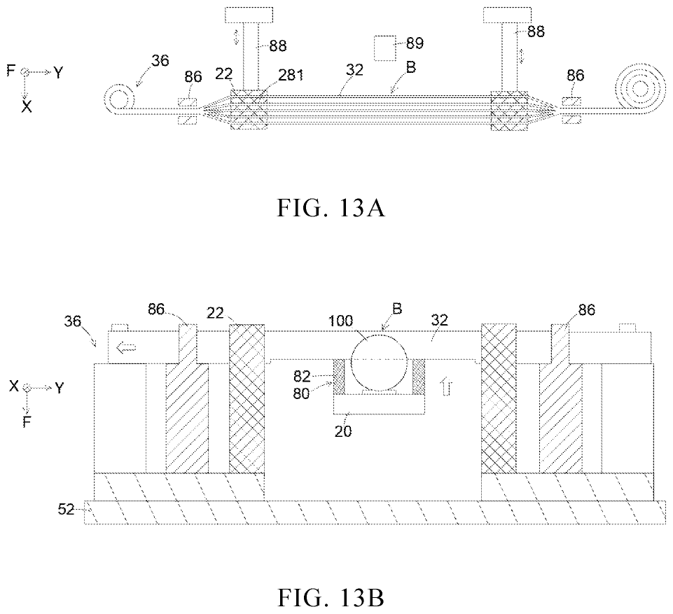

As shown in FIGS. 13A and 13B, the repairing device 80 of the invention can optionally further comprise an orientation correction element 88 used for adjusting relative orientations of the electrode 32 and to-be-machined object 100 according to a deviation phenomenon when deviations occur in the machining direction F of the electrode 32 such as skewed in order to correct the machining direction F of the electrode 32 and the to-be-machined object 100. For example, the orientation correction element 88 can be, for example, a retractable push rod (such as a manual or an electric retractable push rod), for example, by pushing the carrier platform 20, the electrode 32 or other components in the electrical discharge machining apparatus 10 that can change relative orientations of the electrode 32 or the to-be-machined object 100 to achieve, for example, an effect of correspondingly adjusting relative orientations of the electrode 32 and the to-be-machined object 100 along the first direction X. For example, the invention is capable of knowing whether the machining direction F of the electrode 32 deviates, for example, through the detection element 89. Wherein the detection element 89 is, for example, an electrical discharge change detection element, or a photoelectric detection element or an image detection element provided with a light emitter and a light receiver, and is used to know whether the machining direction F of the electrode 32 is deviated through light interruption or light intensity change.

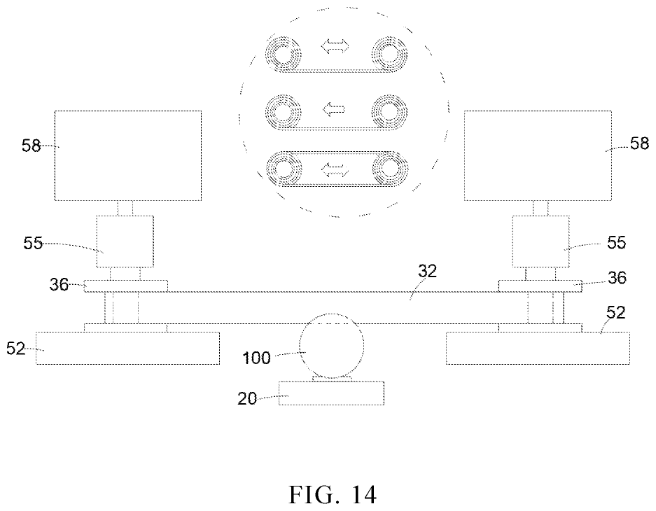

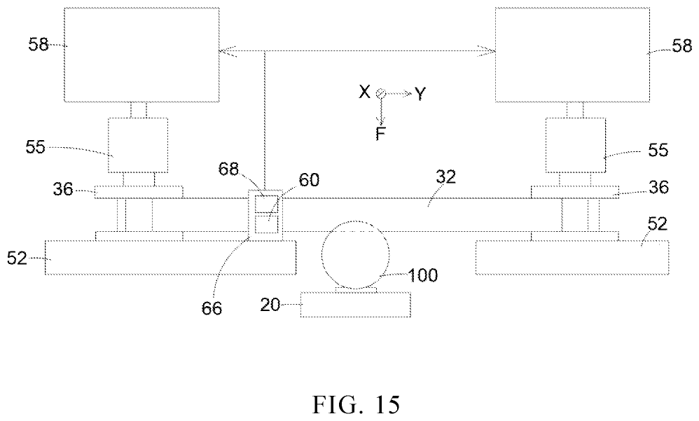

In addition, in the invention, a technical means of jig 36 reciprocating or cyclically scrolling the electrode 32 can adopt a mode as shown in FIG. 14 and FIG. 15, wherein the electrode 32, for example, surround (double-sided across) the two jigs 36 or only one side across the two jigs 36. The two jigs 36 are rotatably disposed on the seat body 52, and the two jigs 36 are connected to two motors 58 via two couplings 55, so that the two jigs 36 are capable of rotating correspondingly through operation of the two motors 58, and making the electrode 32 move reciprocatingly or cyclically along the second direction Y. Since the electrical discharge section B of the electrode 32 is suspended, the invention optionally has a tension control module 66 (as shown in FIG. 15), which for example comprises a tension measurement unit 60 and a controller 68, wherein the tension measurement unit 60 is used to measure a tension value of the electrode 32, and the controller 68 is electrically connected to the two motors 58 to control the two motors 58 according to a tension value of the electrode 32, so that the two motors 58 decrease or increase in rotation speed at a same speed to adjust a tension value of the electrode 32, thereby making the electrode 32 maintain a specified tension value when moving along the second direction Y. In addition, the invention is capable of further calculating a time for the two motors 58 to switch operation directions according to a length and a moving speed of the electrode 32 to achieve an effect of making the electrode 32 reciprocate.

It should be noted that although the invention enumerates a plurality of components to perform one function or more than one function, the invention is not limited thereto. The invention is capable of optionally making a single component perform a plurality of functions, such as integrating the stabilizing member 22 and the adjusting element 87 into one component, or for example, integrating the stabilizing member 22, the adjusting element 87, the clamping element 86, the chip removal element 83 and one component or more than one component of the other components of the electrical discharge machining apparatus 10 into a same component. By the same token, the invention is not limited to selecting all the above-mentioned components, and the electrical discharge machining apparatus 10 of the invention can also select only some of the components from the above-mentioned components to perform the electrical discharge machining procedure.

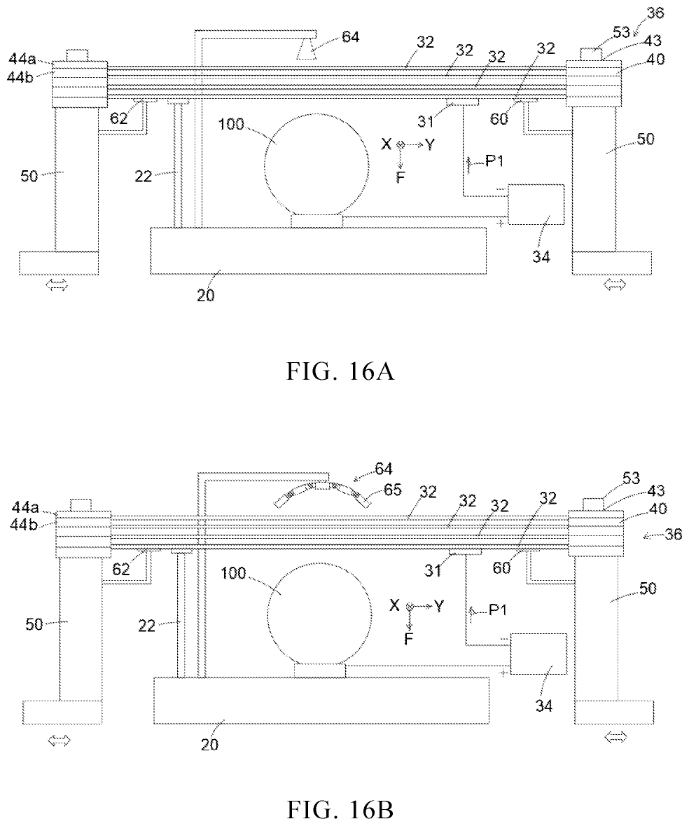

In each of the above implementation examples, the electrical discharge machining unit 30 of the invention can optionally comprise a slag removal unit 64. For example, as shown in implementation examples in FIGS. 16A and 16B, the electrical discharge machining unit 30 of the invention can optionally comprise the slag removal unit 64, when the electrical discharge machining unit 30 performs the electrical discharge machining procedure on the to-be-machined object 100, the slag removal unit 64 provides one external force or more than one external force to eliminate residues generated by an electrical discharge energy applied by the electrode 32 to the to-be-machined object 100. Applied direction or position of the external force generated by the slag removal unit 64 corresponds to the electrical discharge section B of the electrode 32. Wherein the slag removal unit 64 can be, for example, an airflow generator, a water flow generator, an ultrasonic generator, a piezoelectric oscillator or a magnetic force generating element. The external force can be, for example, air flow, water flow, ultrasonic vibration, piezoelectric vibration, suction force or magnetic force. The slag removal unit 64 is not limited to be disposed on the carrier platform 20, and can even be disposed around the electrical discharge section B of the electrode 32. Taking the slag removal unit 64 as an ultrasonic generator or a piezoelectric oscillator as an example, the slag removal unit 64 can be disposed on the jig 36 or the carrier platform 20, for example, and directly acts on the jig 36 or the carrier platform 20 by directly generating an external force. An external force generated by the slag removal unit 64, for example, is capable of also vibrating the jig 36, the to-be-machined object 100 or the electrode 32, vibrating at the same time, for example, to provide an effect of assisting in removal of slag. In addition, as shown in FIG. 16B, the slag removal unit 64 of the invention is capable of also optionally adjusting applied direction and/or applied position of an external force according to a shape of the to-be-machined object 100 to eliminate residues generated by an electrical discharge energy applied by the electrode 32 to the to-be-machined object 100. For example, taking the slag removal unit 64 as a water flow generator capable of spraying water to remove residues as an example, the slag removal unit 64 is, for example, provided with a plurality of nozzles 65 capable of shifting positions, and a spraying direction can be adjusted according to a shape of the to-be-machined object 100. For example, if the to-be-machined object 100 is an ingot, the nozzles 65 of the slag removal unit 64 are distributed on an arc surface of the ingot, and are optionally distributed on two sides of the arc surface of the ingot. Even, the nozzles 65 of the slag removal unit 64, for example, are capable of also optionally adjusting a shape of an arc or positions of the nozzles 65 according to a real-time depth position of electrical discharge machining, thereby achieving an effect of dynamically adjusting water spray according to a shape of the to-be-machined object 100. By the same token, the slag removal unit 64 can also be used as the chip removal element 83. Although a water flow generator is used for the slag removal unit 64 as an example, a person having ordinary skill in the art to which the invention pertains should understand how to modify any feasible slag removal unit 64 to achieve an effect of dynamically adjusting water spray or an effect of dynamically adjusting water spray according to a shape of the to-be-machined object 100 in the invention, so it will not be described in detail herein.

Wherein, in implementation examples shown in FIGS. 16A and 16B, the carrying members 40 respectively comprise a first sheet 44a and a second sheet 44b, and the electrode 32 is clamped between the first sheet 44a and the second sheet 44b, thereby the electrodes 32 can be made parallel to one another in the machining direction F in order to perform the electrical discharge machining procedure on the to-be-machined object 100. For example, the carrying member 40 optionally has a through groove 43, and the carrying member 40 can be sleeved on a protrusion 53 of the holding member 50 through the through groove 43. Since the electrode 32 is clamped on the jig 36, the invention is capable of achieving an effect of quickly replacing the electrode 32 through a quick-release design of the jig 36.

In the invention, a surface of the carrying member 40, for example, optionally has a plurality of limiting grooves 42 (as shown in FIGS. 2A-2C) to limit positions of the electrodes 32 in the limiting grooves 42, the electrodes 32 in the different limiting grooves 42 can be electrically independent, or can be connected in sequence to be electrically connected to one another. A quantity of the electrodes 32 in the different limiting grooves 42 is not limited to be the same, that is, a quantity of the electrodes 32 in the different limiting grooves 42 can also be different from one another. The limiting grooves 42 are also arranged in parallel to one another along the first direction X by spacing apart by a distance D, so that the electrodes 32 are arranged in parallel to one another along the first direction X. A width of the limiting groove 42 corresponds to a width of the electrode 32, for example, a width of the limiting groove 42 is slightly larger than a width of the electrode 32, so that a position of the electrode 32 can be limited in the limiting groove 42. The holding member 50 is optionally detachably or fixedly assembled with the carrying member 40 stably, and there is no special limitation on a combination between the carrying member 40 and the holding member 50, as long as the carrying member 40 can be assembled to the holding member 50, or the carrying member 40 can be optionally moved or rotated by movement or rotation of the holding member 50, it is applicable to the invention. The carrying member 40 is, for example, a cylindrical sleeve (as shown in FIGS. 2A-2C) or a sleeve in another shape with a shaft hole 41, and the carrying member 40 can be sleeved on the protrusion 51 of the holding member 50 through the shaft hole 41. In addition, in order to reduce a time required to replace the electrode 32 when the electrode 32 breaks accidentally, in the invention, for example, the shaft hole 41 of the carrying member 40 can also be sleeved on a dummy support member that also has a protrusion. Thereby, a user is capable of quickly taking out the carrying member 40 surrounded by the electrodes 32 from the dummy support member, and sleeving the shaft hole 41 of the carrying member 40 on the protrusion 51 of the holding member 50, or inserting the protrusion 51 of the holding member 50 into the shaft hole 41 of the carrying member 40, so assembly of the jig 36 can be completed quickly. However, the jig 36 of the invention is not limited thereto, as long as the jig 36 is capable of carrying the electrode 32 to make the electrode 32 perform the electrical discharge machining procedure, any structural design of the jig 36 belongs to a scope of protection claimed by the invention.

In summary, the electrical discharge machining apparatus according to the invention has the following advantages:
(1) The repairing device is capable of repairing the appearance of the electrode through relative displacements between a dressing element and the electrode to prevent short-circuit problem in the electrical discharge machining procedure.
(2) The repairing device is capable of keeping away from the machined target area of the to-be-machined object by scrolling or moving the electrode to avoid short-circuit problem in the electrical discharge machining procedure.
(3) A chip removal element is capable of removing a residual chip and other substances remaining on the dressing element and/or the electrode through relative displacements between the dressing element and the electrode. A slag removal unit is capable of providing an external force for one machined target area or more than one machined target areas to help remove residues generated by the electrical discharge machining procedure or the repairing procedure.
(4) A slitting element is capable of cutting or dividing the electrical discharge section of the electrode into a plurality of electrode strips through relative displacements between the dressing element and the electrode, thereby avoiding uneven wear problem of the plate electrode.
(5) An orientation correction element is capable of correcting the machining direction of the electrode and the to-be-machined object, thereby avoiding deviation of the machining direction.
(6) A clamping element is capable of clamping the electrode to prevent the electrode from changing the machining direction due to being pulled.
(7) An adjusting element is capable of keeping the electrodes parallel to one another to avoid skewing and unevenness on a surface of the to-be-machined object after electrical discharge machining.
(8) A stabilizing member is capable of reducing chattering of the electrode, serving as a separation column to provide a guiding effect, and serving as an electrical contact.

Note that the specification relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An electrical discharge machining apparatus at least comprising:
a carrier platform for carrying at least one to-be-machined object;
an electrical discharge machining unit comprising at least one electrode and a power supply unit, and used for performing an electrical discharge machining procedure on at least one machined target area of the to-be-machined object on the carrier platform by the electrode along a machining direction, wherein the electrode is in a suspended state in an electrical discharge section, the power supply unit provides a first power source to the electrode and the to-be-machined object in the electrical discharge machining procedure for applying an electrical discharge energy to the machined target area of the to-be-machined object through the electrode located in the electrical discharge section; and
a repairing device for performing a repairing procedure on an area to be repaired of an appearance of the electrode to repair the appearance of the electrode.

2. The electrical discharge machining apparatus as claimed in claim 1, wherein the repairing device performs the repairing procedure on the electrode while the electrode performs the electrical discharge machining procedure on the machined target area.

3. The electrical discharge machining apparatus as claimed in claim 1, wherein the repairing device performs the repairing procedure on the electrode before or after the electrode performs the electrical discharge machining procedure on the machined target area.

4. The electrical discharge machining apparatus as claimed in claim 1, wherein the repairing device repairs the appearance of the electrode in a quantitative adjustment manner according to a wear rate of the electrode and a feed speed of the electrical discharge machining procedure.

5. The electrical discharge machining apparatus as claimed in claim 1, wherein the repairing device repairs the appearance of the electrode in a dynamic adjustment manner according to a real-time state of the electrode.

6. The electrical discharge machining apparatus as claimed in claim 1, wherein the repairing device comprises a dressing element, and a relative displacement is generated between the dressing element and the electrode during the repairing procedure to repair the appearance of the electrode.

7. The electrical discharge machining apparatus as claimed in claim 6, wherein the repairing device comprises a lifting mechanism and/or a translation mechanism for disposing the dressing element so that the dressing element is capable of moving to generate the relative displacement with the electrode.

8. The electrical discharge machining apparatus as claimed in claim 6, wherein the dressing element is a laser source, a cutter or a grinding element.

9. The electrical discharge machining apparatus as claimed in claim 6, wherein the repairing device further comprises a chip removal element for removing a residual chip generated when repairing the appearance of the electrode while the repairing device performs the repairing procedure.

10. The electrical discharge machining apparatus as claimed in claim 1, wherein the repairing device comprises a scrolling mechanism for scrolling the electrode during the repairing procedure, so that the area to be repaired of the appearance of the electrode keeps away from the machined target area of the to-be-machined object for repairing the appearance of the electrode.

11. The electrical discharge machining apparatus as claimed in claim 1, wherein the repairing device further comprises a slitting element for dividing the electrode in the electrical discharge section into a plurality of electrode strips parallel to one another.

12. The electrical discharge machining apparatus as claimed in claim 1, wherein the electrical discharge machining unit further comprises a clamping element for clamping at least one side of the electrical discharge section of the electrode when the electrode performs the electrical discharge machining procedure, and releasing the at least one side of the electrical discharge section of the electrode when the repairing device performs the repairing procedure.

13. The electrical discharge machining apparatus as claimed in claim 1, wherein the electrical discharge machining apparatus further comprises a slag removal unit, when the electrical discharge machining unit performs the electrical discharge machining procedure on the to-be-machined object, the slag removal unit provides at least one external force to remove residues produced when the electrode applies the electrical discharge energy to the to-be-machined object.

14. The electrical discharge machining apparatus as claimed in claim 13, wherein the slag removal unit adjusts an applied direction or an applied position of the external force according to a shape of the to-be-machined object to remove the residues.

15. The electrical discharge machining apparatus as claimed in claim 1, wherein the electrical discharge machining unit further comprises:
a jig composed of at least two carrying members and at least two holding members correspondingly assembled, wherein the two holding members are disposed on two seat bodies, and the two seat bodies are moving mechanisms or rotating mechanisms, so that when the electrical discharge machining unit performs the electrical discharge machining procedure along the machining direction, the electrical discharge section of the electrode and the machined target area of the to-be-machined object move relative to each other in a reciprocating or cyclical manner.

16. The electrical discharge machining apparatus as claimed in claim 15, wherein the electrode abuts against the two carrying members in a surrounding manner or abuts against the two carrying members with two sides of the electrode respectively, so that the electrode is in the suspended state in the electrical discharge section.

17. The electrical discharge machining apparatus as claimed in claim 1, wherein the repairing device further comprises an orientation correction element for adjusting a relative orientation of the electrode and the to-be-machined object to correct the machining direction according to a deviation phenomenon in the machining direction of the electrode.

18. The electrical discharge machining apparatus as claimed in claim 1, wherein the repairing device moves a position of the electrode with the area to be repaired appearing on the appearance of the electrode, so that the area to be repaired keeps away from the machined target area of the to-be-machined object, and the area to be repaired is a fracture phenomenon or a fracture sign.

19. The electrical discharge machining apparatus as claimed in claim 1, wherein a quantity of the electrode is multiple, and the electrodes are arranged parallel to one another along a first direction and/or a third direction in the electrical discharge section, wherein the third direction is perpendicular to the first direction.

20. The electrical discharge machining apparatus as claimed in claim 19, wherein the repairing device further comprises an adjusting element, and the adjusting element separates the electrodes so that the electrodes are maintained to be parallel to one another in the electrical discharge section.

21. The electrical discharge machining apparatus as claimed in claim 19, wherein the electrical discharge machining unit further comprises a separation column, and the electrodes abut against the separation column, so that the electrodes are arranged parallel to one another in the electrical discharge section.

22. The electrical discharge machining apparatus as claimed in claim 19, further comprising a stabilizing member, the stabilizing member having a plurality of guide grooves for movably accommodating the electrodes, and being used to stabilize and guide the electrodes, so that the electrodes being capable of performing the electrical discharge machining procedure along the machining direction.

23. The electrical discharge machining apparatus as claimed in claim 19, wherein the repairing device moves a position of at least one of the electrodes with the area to be repaired appearing on the appearance of the electrodes, so that the area to be repaired keeps away from the machined target area of the to-be-machined object, and the area to be repaired is a fracture phenomenon or a fracture sign.
